(19) United States
(12) Patent Application Publication
(10) Pub. No.: US 2008/0250246 A1
(43) Pub. Date: Oct. 9, 2008

(54) Method for Controlling Secure Transactions Using a Single Multiple Dual-Key Device, Corresponding Physical Deivce, System and Computer Program

(75) Inventors: David Arditti, Clamart (FR); Sidonie Caron, Clamart (FR); Laurent Frisch, Paris (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: France Telecom, Paris (FR)

(21) Appl. No.: 11/996,179

(22) PCT Filed: Jul. 18, 2006
(86) PCT No.: PCT/EP2006/064384

§ 371 Date: Jun. 20, 2008

(30) Foreign Application Priority Data
Jul. 26, 2005 (FR) 05/07991

(51) Int. Cl. H04L 9/06

(52) U.S. Cl. 713/173

(57) ABSTRACT

A device is provided for controlling secure transactions using a physical device held by a user and bearing at least one first pair of asymmetric keys, including a first device public key and a first corresponding device private key. The control includes, prior to implementing the device, certifying a first device public key and characteristics data of the physical device by signing with a first certification key, delivering a factory certificate, after verifying that the device private key is housed in a tamper-proof zone of the physical device. At least one second pair of asymmetric keys is generated, including a second device public key and a second device private key housed in a tamper-proof zone of the device. A second device public key is certified by signing with at least the first device private key, delivering a provisional certificate. The factory and provisional certificate are verified using, respectively, a second certification key corresponding to the first certification key, and the first device public key. In case of positive verification, the method includes delivering by a trusted third party a device certificate corresponding to the signature by the provider at least the second device public key and an identifier of the user and the characteristic data of the device.

### CROSS-REFERENCE TO RELATED APPLICATIONS

This Application is a Section 371 National Stage Application of International Application No. PCT/EP2006/064384, filed Jul. 18, 2006 and published as WO 2007/012584 A1 on Feb. 1, 2007, not in English.

### FIELD OF THE DISCLOSURE

The field of the disclosure is that of the securing of electronic transactions, implementing especially authentication, electronic signing and payment operations performed by means of communications networks such as the Internet for example.

More specifically, the disclosure relates to a technique for the control of secured transactions bringing into play a physical device that is in the possession of a user and can be used to perform transactions with several providers or providers of distinct goods or services.

### BACKGROUND OF THE DISCLOSURE

The strong growth of communications networks such as the Internet for example and the constant increase in the number of daily transactions on these networks has given rise to a constantly increasing need for the securing of transactions. Indeed, it has been seen to be necessary that the environment of trust surrounding physical exchanges by conventional mail or by direct contact should be reproduced in these information technology or radio communications networks.

In the prior art, a certificate is used in particular to verify the validity of a public cryptographic key used in a computer network. This certificate is a message comprising at least a public key, an identifier of its holder, a period of validity, an identification of a certifying authority and a cryptographic signature of these different pieces of data, obtained by means of the secret key of this certification authority that has issued the certificate.

The reading of the certificate enables the authentication with certainty of the sender of a message received in the case of the signature and of the identifier of the entity authenticating itself in the case of authentication.

For further information on the certificate, reference may be made especially to the standard X.509, and more particularly X.509v3 defined in the RFC3280 (Request For Comment n20 3280) published by the IETF (Internet Engineering Task Force).

When a customer wishes to authenticate himself or set down a signature in using n identifiers {Id₁, Id₂, . . . , Idₙ} in a totally independent way, he uses several pairs of asymmetrical keys (Sᵢ, Pᵢ), or i=1, . . . , n. The certificates Cᵢ issued by a certification authority then link the different public keys Pᵢ to the identifier Idᵢ, as well as to other pieces of information if any.

Then n triplets (Pᵢ, Sᵢ, Cᵢ) are defined, each associated with a distinct identifier Idᵢ, and constituted by a public key Pᵢ, a private key Sᵢ and a certificate Cᵢ.

When the customer wishes to make a secured transaction with the i^{th} provider, he will sign a random value sent by the provider (the term used then is authentication) or a message (the term used then is electronic signing) using his secret key Sᵢ and associating thereto the corresponding certificate Cᵢ given by the certification authority (which, as the case may be, is the provider himself) according to standardized protocols.

Thus, the untraceability of the customer is guaranteed, even he carries out transactions with different providers.

However, one drawback of the prior art technique referred to here above is that it does not enable a certification authority or provider to make sure simply, and remotely, that the certificate Cᵢ that it issues or uses will certify a public key Pᵢ corresponding to a private key Sᵢ stored in a given physical device.

Indeed, the behavior of a physical device can be totally simulated by a software program so that, at a distance, it is impossible for the provider to know if it corresponds to a physical device or else to a software emulation of such a device.

Now, there are several circumstances in which it is important for a provider to have proof that he is communicating with a genuine physical device.

Indeed, if the private key Sᵢ of the physical device remains stored, in accordance with the good practice, in a secret and inaccessible zone, the physical device cannot be cloned and is therefore a unique object which alone is capable of producing the authenticators and signatures corresponding to the public key Pᵢ, and hence to the certificate Cᵢ, and hence also to the identifier Idᵢ by which the customer is known to the i^{th} provider. Only the possessor of the physical device can then authenticate himself or sign with the identifier Idᵢ with respect to the i^{th} provider. This constitutes a strong property of non-repudiation, a pledge of security for the provider.

Another circumstance in which it is important for the provider to be able to make sure that he is dealing with a given physical device is when this physical device is the medium of a paid subscription to a service provided by the provider (for example access on the Internet to newspaper articles published in a daily). Access to the paid service is conditional, for the user, on the opening of a session with the provider during which he authenticates himself by means of his physical device.

It is therefore particularly important for the provider to make sure that the customer who wishes to access the service is truly in possession of the physical device in order to prevent several persons from being able to access the service (simultaneously or otherwise) in paying only one subscription. This would be the case if the subscription medium could be cloned (for example if the subscription medium were to be an “identifier/password” set or a private key (even enciphered) stored in a hard disk drive).

The French patent application FR 96 08692 entitled “Procèdè de contrôle de transactions sècurisèes indèpendantes utilisant un dispositif physique unique” (Method for the control of independent secured transactions using a single physical device), filed on behalf of the applicant of the present patent application provides a more particular description of a physical device used to perform authentication with one or more providers, with whom the user of the device wishes to carry out a transaction.

In this method, the users are provided with physical devices such as chip cards or USB (universal serial bus) dongles which are classically associated with a pair of asymmetric keys (P₀, S₀) comprising one private key S₀ and one public key P₀. The private key S₀ is an electronic element that must remain secret and is therefore stored in a protected space of the physical device, sheltered from any attempt at intrusion. The public key P₀ for its part can be stored in a freely read-accessible state in the physical device or it may be delivered to the user on an external carrier such as a floppy disk, a CD-Rom, a paper document or a reserved space in a data server. This pair of keys (S₀, P₀) is created in the factory, prior to the commercial distribution and commissioning of the device.

A physical device of this kind also comprises computation means to perform an authentication and/or signature asymmetric cryptographic algorithm. Among the algorithms of this kind, we may cite algorithms of the RSA (Rivest-Shamir-Adleman), DSA, GQ (Guillou-Quisquater) or GPS type for example.

The use of this asymmetric cryptographic algorithm may be subject to the prior presentation of a carrier code (or PIN (personal identification number) code) initialized in a phase of pre-personalization of the physical device, and managed according to classic techniques which are not the object of the present patent application.

The physical device can then be sold in this form to a user by means of a distribution means independent of any provider.

To enable the performance of a secured transaction (authentication, signature) with a provider, the user of the physical device, also called a customer, must obtain issuance, from the provider or from an independent certification authority, of a certificate C₁ linking the public key P₀ of the device and an identifier Id₁ relevant to the provider (note: in systems where the anonymity of the user relative to the provider must be preserved, the identifier Id₁ is different from the user's civil identity).

This operation called “registration” can be done with n distinct providers, so that the customer is assigned n certificates {C₁, C₂, . . . , Cₙ} linking n identifiers {Id₁, Id₂, . . . , Idₙ} (each of them being relevant to a given provider) to said public key P₀.

According to the prior art, the only method by which a provider or a certification authority can make sure that the transaction in progress is being actually done by means of a given physical device relies on the physical handling of the device by the provider or certification authority. Indeed, he or it can then read the public key P₀ or Pᵢ in the device for himself or itself, should it be stored therein; if this is not the case, he or it can make the device sign a random value by means of the secret key S₀ or Sᵢ, and then verify the result of this signature by means of the public key P₀ or Pᵢ given by the customer on an external carrier.

However, one drawback of this prior art approach is that it requires the provider or certification authority to be capable of physically operating on the device, and therefore excludes any remote action. This can prove to be problematic, in the context of transactions performed in modem communications networks such as the Internet.

Furthermore, in the case of the method of the patent application FR 96 08692, since all the certificates {C₁, C₂, . . . , Cₙ} use the same public key P₀, it is possible for an ill-intentioned entity to correlate the different identifiers {Id₁, Id₂, . . . , Idₙ} of the customer. This is a drawback should it be sought to ensure the untraceability of the user of the physical device.

### SUMMARY

An aspect of the disclosure relates to a method for the control of secured transactions implementing a physical device held by a user and bearing at least one first pair of asymmetric keys, comprising a first device public key (P₀) and a corresponding first device private key (S₀), said first device private key.

According to an embodiment of the invention, a control method of this kind comprises the following steps:

prior to the commissioning of said physical device, a first step of certifying said first device public key (P₀) and pieces of information (<info>) characteristic of the physical device by signing with a first certification key (S_{T}) of a particular certification authority (ACP), issuing a factory certificate (C₀), after verification that said device private key S₀ is housed in a tamper-proof zone of said physical device;

a step of generation of at least one second pair of selected keys, comprising a second device public key (Pᵢ) and a second device private key (Sᵢ) (i=1, . . . ), said second device private key (Sᵢ) being housed in a tamper-proof zone of said device;

a second step of certification of said second device public key (Pᵢ) through signing by means of said first device private key (S₀), issuing a provisional certificate (C′ᵢ)

a first step of verification of said factory certificate (C₀) by means of a second certification key (P_{T}) corresponding to said first certification key (S_{T});

a second step of verification of said provisional certificate (C′ᵢ) by means of said first device public key (P₀);

in the event of positive verification of said factory certificate (C₀) and said provisional certificate (C′ᵢ), a step of issuance by a trusted third party of a device certificate (Cᵢ) corresponding to the signing of at least said second device public key (Pᵢ), an identifier (Idᵢ) of said user and said pieces of information (<info>) characteristic of the device.

Thus an embodiment of the invention relies on a wholly novel and inventive approach to the securing of electronic transactions performed by means of a physical device of the USB dongle, chip card or other type, for which it is desired to ensure the untraceability of the user.

Indeed, the technique of an embodiment of the invention relies:

firstly on the use of several pairs of asymmetric keys of the device, each pair being associated with a distinct identifier of the customer, and making it possible to ensure his or its untraceability with respect to the different providers with which her or it gets connected;

and, secondly, upon the action, in order to introduce an additional degree of securing, of a particular certification authority (ACP), in which the different levels of certification and the different providers place all their trust. This particular certification authority, prior to the commissioning of the physical device (USP dongle, chip card etc), issues a certificate relating to this physical device (and not, as in the prior art, a certificate relating to an identifier of its holder), thus enabling a check to be made on whether the first public key P₀ of the physical device truly corresponds to a first private key S₀ stored, in accordance with good practice, in a secret zone of the device. The ACP therefore certifies the physical device.

A provisional certificate C′ᵢ, produced (generally by the device itself) using the secret key S₀ whose corresponding public key P₀ is certified by the ACP, makes it possible for its part to guarantee that a second public key Pᵢ of the physical device truly corresponds to a second device private key Sᵢ also stored, in accordance with good practice, in a secret, tamper-proof zone of the device. This device public key Pᵢ is such that it is used by the customer to carry out a transaction with an i^{th} provider.

The verification of the validity of these two certificates, the factory and provisional certificates, is a guarantee, for the trusted third party, that even at a distance, he or it is in the presence of a real physical device and not a piece of equipment (computer, PDA etc) that would be fraudulently reproducing its behavior.

Finally, the verification of the validity of the device certificate Cᵢ and the examination of the field <info>is a guarantee, for the provider, that even at a distance, he or it is in the presence of a real physical device and not a piece of equipment (computer, PDA etc) that would be fraudulently reproducing its behavior.

Thus, a chain of trust is built between the provider who places his trust in a trusted third party, verifying the factory and provisional certificates, and who himself places full trust in the particular certification authority issuing the factory certificate C₀. Thus, the transaction control method of an embodiment of the invention uses the undertaking of the ACP to provide assurance to a provider that the customer who wishes to enter into a secured transaction truly possesses a physical device which has been certified by the ACP. Thus, there is a sharp distinction with respect to the prior art which does not provide any assurance, at a distance, that the user possesses a physical device. Indeed, the control techniques of the prior art ensure only the identification of the user, if need be by means of a stringing of authentications and certifications based on the use of a succession of certification authorities, but always have only one consequence which is the certification of the identity of a user. In addition to the certification of the user's identity, the method of an embodiment of the invention comprises the preliminary certification of the physical device subsequently held by this user. This makes it possible to provide assurance to a provider, possibly at a distance, that the user who authenticates himself with this provider possesses a physical device. Only this assurance enables the setting up of the transaction control process to be continued.

Furthermore, the on-the-fly generation, by the physical device, of other pairs of asymmetric keys corresponding to a need to set up a secured transaction between a provider and a user ensures the non-repudiation of the keys generated, owing to the use of the secret key S₀ to certify this pair of keys. Indeed, since S₀ cannot be replaced by another key owing to the certification by the ACP of P₀, the certificates resulting from the signature by S₀ of the pairs of asymmetric keys cannot be repudiated.

Advantageously, a control method of this kind is implemented for at least two second pairs of asymmetric keys of said device, each associated with an identifier (Idᵢ) of said user, and each of said device certificates (Cᵢ) issued during said steps of issuance links one of said second device public keys (Pᵢ) to said associated identifier (Idᵢ).

The physical device may also be used in transactions with several providers, with each of whom the user is identified by a distinct identifier Idᵢ.

Preferably, said pieces of information characteristic of said physical device belong to the group comprising the following pieces of information:

type of physical device (chip card, USB dongle etc);

identification of the manufacturer of said physical device;

type of cryptographic algorithm used by said physical device: RSA, GQ, etc.);

serial number of said physical device.

According to one advantageous characteristic of an embodiment of the invention, at the time of a transaction, said provider consults said information (<info>) characteristic of said device certificate (Cᵢ).

Preferably, a control method of this kind comprises a phase of personalization of said physical device, during which said first pair of asymmetric keys, said factory certificate (C₀), and said pieces of information (<info>) of said factory certificate are associated solely with said physical device so as to reduce the risks of fraudulent transactions. This phase of personalization may be performed for example in the factory, before the commercial distribution of the device.

Advantageously, said factory certificate (C₀) and provisional certificate (C′ᵢ) are stored in at least one freely read-accessible memory zone of said physical device. They are thus easily accessible to the provider or to the trusted third party.

Preferably, at least one of said first and second verification steps is performed by said provider.

According to a first advantageous variant, said first certification key (S_{T}) is a private key and said second certification key (P_{T}) is a public key.

According to a second advantageous variant, said particular certification authority uses a symmetrical key (K), so that said first certification key (S_{T}) and said second certification key (P_{T}) are identical.

An embodiment of the invention also relates to a physical device held by a user and designed to be used during secured transactions, said physical device bearing at least one first pair of asymmetric keys comprising a first device public key (P₀) and a corresponding first device private key (S₀).

According to an embodiment of the invention, a device of this kind also carries a factory certificate (C₀), issued after it has been verified that said device private key S₀ is housed in a tamper-proof zone of said physical device corresponding to the signing of said first device public key (P₀) and of information (<info>) characteristic of the physical device by a first certification key (S_{T}) of a particular certification authority (ACP), at least one second pair of asymmetric keys comprising a second device public key (Pᵢ) and a second corresponding device private key (Sᵢ), said first device private key (S₀) being housed in at least one tamper-proof zone of said device, and a provisional certificate (C′ᵢ) corresponding to the signing of said second device public key (Pᵢ) by said first device private key (S₀). Furthermore, said factory certificate (C₀) is stored in said physical device prior to its commissioning.

An embodiment of the invention also relates to a computer program product downloadable from a communications network and/or stored on a carrier that is computer-readable and/or executable by a microprocessor, which comprises program code instructions to implement at least one step of the method for controlling secured transactions as described here above.

An embodiment of the invention also relates to a system for the controlling of secured transactions in a communications network, implementing a physical device held by a user and bearing at least one pair of asymmetric keys, comprising a first device public key (P₀) and a corresponding first device private key (S₀).

According to an embodiment of the invention, a control system of this kind comprises at least:

a particular certification server connected to said network, issuing to said physical device, after verification that said device private key S₀ is housed in a tamper-proof zone of said physical device and prior to its commissioning, a factory certificate (C₀) corresponding to the signing of said first device public key (P₀) and pieces of information (<info>) characteristic of the physical device by a first certification key (S_{T}) of said particular certification server (ACP);

a trusted third party (44) verifying said factory certificate (C₀) by means of a second certification key (P_{T}) corresponding to said first certification key (S_{T}), and a provisional certificate (C′ᵢ) stored in said physical device, corresponding to the signing of a second device public key (Pᵢ) by said first device private key (S₀), by means of said first device public key (P₀), and issuing to said user, in the event of positive verification, a device certificate (Cᵢ) corresponding to the signing by said trusted third party (44), of at least said second device public key (Pᵢ), an identifier (Idᵢ) of said user and pieces of information (<info>) characteristic of the device, said trusted third party being linked to said network.

### BRIEF DESCRIPTION OF THE DRAWINGS

Other features and advantages shall appear more clearly from the following description of the preferred embodiment, given by way of a simple, non-restrictive illustration, and from the appended drawings of which:

FIG. 1 illustrates the principle of certification, by a particular certification authority, of the public key of a physical device during a phase of personalization of the device;

FIG. 2 presents the principle of the creation of a second pair of asymmetric keys (Pᵢ, Sᵢ), as well as a provisional certificate C′ᵢ in a physical device;

FIG. 3 is a block diagram of the different steps implemented in the method of the invention for controlling secured transactions; and

FIG. 4 describes the different exchanges between a user and different servers of an embodiment of the invention, through a communications network, in the context of the method of FIG. 3.

### DETAILED DESCRIPTION OF ILLUSTRATIVE EMBODIMENTS

The general principle of an embodiment of the invention is based on the certification of the public keys P₀ and Pᵢ of a physical device enabling a provider to be given a guarantee, during a secured transaction (possibly a remote transaction), that he is truly dealing with a genuine physical device in which the corresponding private keys S₀ and Sᵢ are stored, while at the same time ensuring that the user of this device is untraceable by the provider.

FIG. 1 present an embodiment of the certification of the public key P₀ of a given physical device 13. Such a certification may take place during the standard phase of personalization in the factory of the physical device 13 during which the device is equipped with a quadruplet (P₀, S₀, C₀ and <info>).

A particular certification authority or ACP, 10 has a pair of asymmetric keys(P_{T}, S_{T}) comprising a public key P_{T} and a private key S_{T} kept in a secret and inaccessible zone 101. An ACP 10 of this kind is for example the manufacturer of the physical device: the secret zone 101 in which the private key S_{T} is memorized is then a particular physical device (a chip card for example) held by the manufacturer or a restricted-access protected memory zone of one of his computer installations.

The public key P_{T} for its part is published by the ACP 10, or supplied at the request of one of the potential providers who might have need of it (i.e. trusted third parties liable to make transactions with the holder of the physical device 13).

During the manufacture of the physical device 13, a pair of asymmetric keys (P₀, S₀) is recorded therein. This pair of asymmetric keys (P₀, S₀) comprises a public key P₀, stored in a read-accessible zone 131 of the device 13 and a private key S₀ stored in a protected zone 132 of this device 13. This protected or tamper-proof zone 132 is designed so as to prevent the reading of the private key S₀ and resist any attempt at software or hardware intrusion. Indeed, the use of the private key S₀ by the device 13 is highly constrained: especially, as explained here below, the device 13 cannot use this device private key S₀ to produce external data signatures. As a variant, the public key P₀ can also be communicated to the holder of the physical device 13 on an external support independent of the device itself.

As indicated here above, if the ACP 10 is the manufacturer of the physical device 13, the operations illustrated in FIG. 1 are performed before the commercial distribution of the physical device, in the factory, during a personalization phase. If it is a certification authority independent of the manufacturer, these operations may be performed when the physical devices come off the production lines, before they are distributed to the final users.

More specifically, the physical device 13 communicates 11 its device public key P₀ to the ACP 10. The factory certificate C₀ issued by the ACP 10 may correspond to the signing by the ACP 10 of the device public key P₀ and of the field <info>, which is a field grouping together a set of pieces of information characteristic of the device 13 (for example the manufacturer's name, the type of device, the nature of the cryptographic signature algorithms used by the device, etc).

This signature 12 constitutes a factory certificate C₀=A(S_{T},P₀,<info>) (where A designates a cryptographic signature algorithm of the RSA type for example) which, like the device public key P₀ could be written in the physical device 13 in a freely read-accessible zone 131, or given to the user of the device 13 on an external carrier (floppy disk, CD-ROM, paper document etc).

The ACP thus initially certifies that the device private key of the device S₀ is housed in a physical device 13 of characteristics given by the field <info>. Like the device public key P₀ and the factory certificate C₀, the field <info>may be stored so as to be freely read-accessible in the zone referenced 131 of the device 13, or on an external carrier or it may simply be communicated to the providers or trusted third parties who might have need of it.

The ACP 10 (manufacturer or trusted third party) naturally undertakes not to produce such factory certificates C₀ (i.e. such signatures with its private key S_{T}) except for public keys P₀ corresponding to private keys stored in a given type of physical device.

The certification operations of FIG. 1 may also, in one alternative embodiment of the invention, be mutualized for several manufacturers of different types of physical devices. In this case, the ACP 10 is a trusted third party, independent of all the manufacturers, that holds the private key S_{T}, and, in order to produce the factory certificate C₀ of a given physical device 13, signs the pair (P₀, <info>) with its private certification key S_{T}. The pieces of characteristic information contained in the field <info>enable information to be obtained for example on the nature of the device 13, i.e. whether it is a USB dongle, a chip card etc. It may also be the product reference used by the manufacturer to designate one of the devices that he builds.

Similarly, as a variant, other pieces of information relevant to the use of the physical device 13 may be signed into the factory certificate C₀, for example information such as the manufacturer's name (<manufacturer's name >), the type of cryptographic algorithm used (<type of algorithm>), the serial number of the device etc.

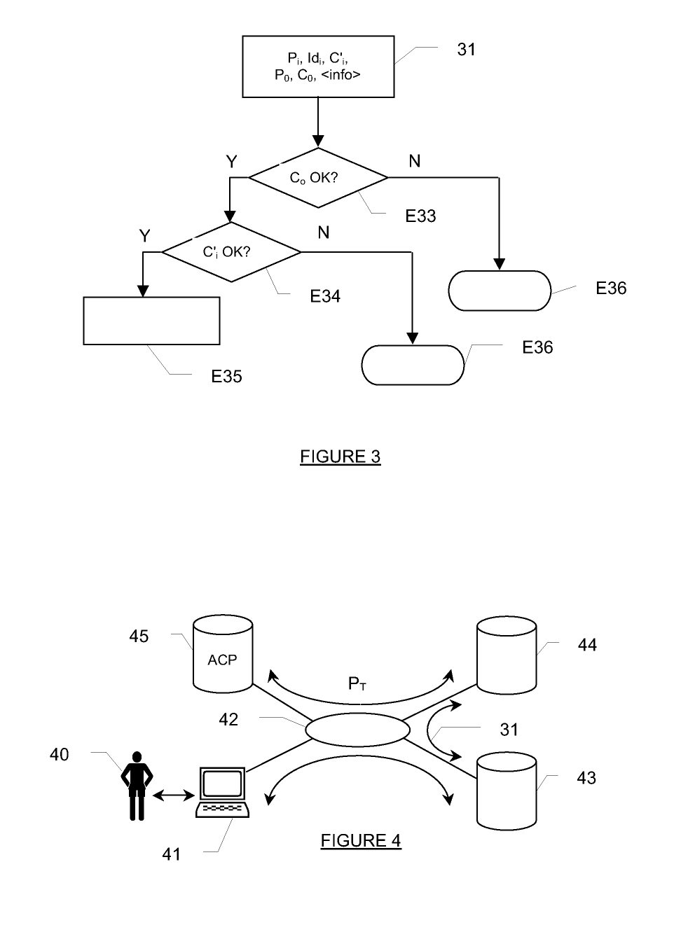

Thus, during a subsequent phase of verification of the factory certificate C₀ by a provider (described here below in greater detail with reference to FIGS. 3 and 4), this provider will have the assurance that the device public key P₀ corresponds to a secret key S₀ stored in a <info>type device 13 manufactured by <manufacturer's name>, and using the cryptographic algorithm <type of algorithm>. This assurance results from the trust placed by the provider in the particular certification authority 10.

It can also be imagined, as a variant of the operations illustrated in FIG. 1, that P_{T}=S_{T}=K is a symmetrical key.

In this case, the key K can be shared between the manufacturer of the physical device 13 and one (or a few rare) trusted third parties of whom the manufacturer knows that they will keep this key K secret; in this case, only the third parties or the manufacturer himself would be able to verify the certificate.

It is also possible to envisage a case where the key K is used only by an ACP 10 independent of the manufacturer, which signs the symmetrical key factory certificate C₀ solely at the request of the manufacturer of the physical devices 13. Similarly, this ACP 10 will be the only entity capable of verifying the factory certificates C₀, at the request of the providers wishing to perform a transaction with the associated physical devices 13. Once again, this APC 10 can of course be the manufacturer himself.

The quadruplet (P₀, S₀, C₀, <info>) may be characteristic of a given physical device 13 or it may be the same for all the physical devices 13 having identical characteristics described in the field <info>. In this case, it is not necessary bring in the ACP 10 during the personalization of the device 13, because the quadruplet (P₀, S₀, C₀, <info>) is constituted once and for all for a series of given devices.

The physical device 13 in which the certificate C₀ has been registered by the ACP 10 is vended by a distribution means independent of any provider, for example in a big store or by a certified retailer.

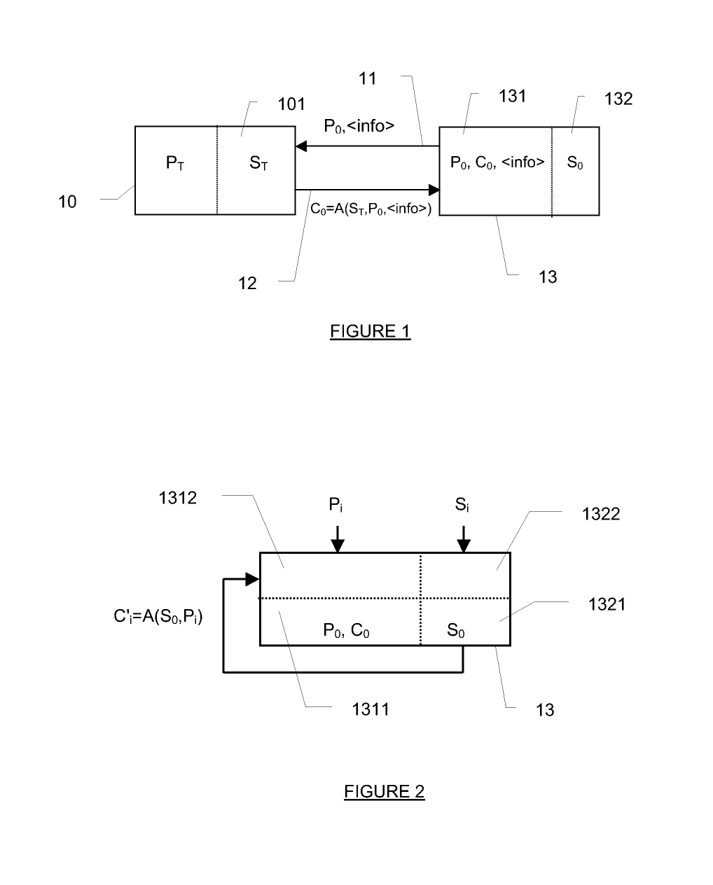

It may then be used to make secure transactions with a provider, necessitating the implementation of a registration phase described in greater detail with reference to FIG. 2.

Such a registration comprises

a first operation for creating a second pair of asymmetric device keys (Pᵢ, Sᵢ), which be used during exchanges with the provider No. i;

a second operation for the issuance of the device certificate Cᵢ by a trusted third party.

Repeating the notations and numerical references of FIG. 1, the physical device 13 comprises, in a freely read-accessible memory zone 1311, a first device public key P₀, a factory certificate C₀, and possibly a field <info>which has not been shown in FIG. 2. The physical device 13 also comprises a first device secret key S₀, in a tamper-proof memory zone 1321.

In order to ensure the untraceability of the user of the device 13, as the case may be during his various exchanges with the providers, it is necessary in such a case to store other pairs of asymmetric keys (Pᵢ, Sᵢ) in the device 13, which it can then use to carry out signing operations and authenticate itself with an i^{th} provider.

Two approaches may be envisaged for the creation of these pairs of additional asymmetric keys (Pᵢ, Sᵢ).

In a first alternative embodiment, this pair (Pᵢ, Sᵢ) is created by the physical device 13 itself. Indeed, many cryptographic devices are capable of self-generating their keys according to a technique classically known as “on board key generation”. It is an APDU (“Application Protocol Data Unit” that activates the process of generation of the keys (Pᵢ, Sᵢ). The device public key Pᵢ is then housed in a read-accessible zone 1312 of the physical device 13 and the device private key Sᵢ is housed in a tamper-proof zone 1322 having specific conditions of access. Indeed, a tamper-proof zone 1322 such as this is neither read-accessible nor write-accessible, and only an adapted cryptographic signature algorithm can use this device secret key Sᵢ. Furthermore, this use is subjected to the preliminary, accurate presentation of a bearer code (or PIN code).

In this first alternative embodiment, the APDU for the generation of keys (Pᵢ, Sᵢ) implemented in the physical device 13 also performs an additional operation consisting of the signing of the second device public key Pᵢ with the first device private key S₀ housed in the tamper-proof zone 1321. This signing is a provisional certificate C′ᵢ=A(S₀,Pᵢ) (where A is the cryptographic signature algorithm, for example of the RSA or GQ type) which is also stored in a read-accessible zone of the physical device 13, for example the zone 1312 in which the device public key Pᵢ is already stored.

In a second alternative embodiment, the pair of additional asymmetric keys (Pᵢ, Sᵢ) is created outside the physical device 13, for example by a computer equipped with a security module. A specific APDU is then implemented in the physical device 13. This specific APDU enables:

the introduction of the second device private key Sᵢ in the tamper-proof zone 1322, for example by means of an enciphered transportation of this key Sᵢ between the security module of the computer that has created it and the physical device 13;

the writing of the second device public key Pᵢ in a read-accessible zone 1312 of the physical device;

the signing of the second device public key Pᵢ by means of the first device private key S₀, and the storing of the provisional certificate C′ᵢ thus obtained in a read-accessible zone 1312 of the physical device.

Whether the pair of keys (Pᵢ, Sᵢ) has been created inside or outside the physical device 13, this physical device 13, at the end of this operation, has a triplet (Pᵢ, Sᵢ, C′ᵢ), whose different elements are stored in the zones of the device 13 in adequate conditions of access.

Such an operation for the generation of a triplet (Pᵢ, Sᵢ, C′ᵢ) can be done several times, to equip the physical device 13 with a plurality of such triplets, and therefore permit the user to carry out secure transactions with several distinct providers, while at the same time ensuring his untraceability.

It will be noted that, in each of these two alternative embodiments, the read-accessible zones 1311 and 1312 may or may not be the same. This is also the case for the restricted-access tamper-proof zones 1321 and 1322.

The issuance of the provisional certificate C′ᵢ must constitute the only possible use of the first device private key S₀. In other words, according to an embodiment of the invention, the first device private key S₀ can be used only for the signing, within a single APDU, of the public keys Pᵢ, whether they have been generated by the physical device or introduced into it in the form of a pair of asymmetric keys (Pᵢ, Sᵢ).

Referring now to FIGS. 3 and 4, we present the way in which the factory certificate C₀ and provisional certificate C′ᵢ used for the issuance to the user 40 of the physical device 13 of a device certificate Cᵢ.

The physical device 13 has been acquired by the user 40 who wishes to use it to access the services proposed by a provider 43 through a communications network 42, for example the worldwide network known as the Internet. A provider 43 of this kind may be, for example, a services provider (providing access to a weather news service or to a geolocation service for example) or a vendor of goods (a trader on the Internet for example). The physical device 13 is used for example as a carrier with a paid subscription service taken by the user 40 with the provider 43 (for example a subscription to a daily horoscope published on the Internet).

To be able to access the services of the provider 43, the user 40 must register with a trusted third party, i.e. he must obtain issuance of a device certificate Cᵢ, that contains the signature by the trusted third party 44 of the device public key Pᵢ, and identifier Idᵢ of the user, as well as other pieces of information, such as the date of validity of the certificate etc. To preserve the anonymity of the user 40, the identifier Idᵢ may defer the civilian identity of the user. It should be noted that the problem of correspondence between the identifier Idᵢ and the real identity of the user is not the object of the present invention and shall therefore not be described in greater detail here below. For a solution to this problem, reference when he may for example to the French patent document FR 04 08992 filed on behalf of the parties filing the present patent application.

To enable issuance E35 of the device certificate Cᵢ, the trusted third party 44 who, if necessary, may be the provider 43, must have the following elements 31 available:

the device public keys P₀ and Pᵢ;

the factory certificate C₀ and provisional certificate C′ᵢ;

an identifier Idᵢ of the user 40;

characteristic information <info>of the physical device 13.

The trusted third party 44 must also have available other pieces of information required according to the X.509 standard referred to here above, for example the date of validity of the device certificate Cᵢ to be issued, certain pieces of information on the use of the different keys, etc.

The way in which the certification authority acquires knowledge of these different elements 31 is not the object of the present patent application and shall therefore not be described herein in greater detail. It is assumed here below that the certification authority is truly in possession of these different pieces of information 31.

Apart from the conventional verification operations dictated by the standard X.509 which are not described in this document, the trusted third party performs various complementary operations of verification within the context of the invention.

According to an embodiment of the invention, the trusted third party carries out the verification E33 of the factory certificate C₀, by means of the public key P_{T} of the particular certification authority 10 in order to verify that the device public key P₀ which has been transmitted to the provider 43 truly corresponds to a secret key S₀ stored in a physical device described by the field <info>. An operation E33 such as this consists in verifying that the signature of the device public key P₀ and of the field <info>contained in the factory certificate C₀ is exact.

In the event of negative verification, i.e. if the factory certificate C₀ does not correspond to the signing of the public key P₀ of the physical device and of the field <info>by the private certification key ST of the ACP 10, the trusted third party 44 can bring an end E36 to the transaction and refuse issuance of the device certificate Cᵢ.

However, in the event of positive verification, the trusted third party acquires certainty that the public key P₀ truly corresponds to a private key S₀ housed in a physical device 13 having <info>characteristics, and can then carry out the verification E34 of the provisional certificate C′ᵢ, by means of the first public key of the device P₀.

If the signature C′ᵢ of the second public key of the device Pᵢ is not exact, the trusted third party 44 can bring the exchanges with the user 40 to an end E36.

If on the contrary the signing C′ᵢ of the second device public key Pᵢ is exact, the trusted third party 44 acquires the certainty (inasmuch as it trusts the ACP 10) that the device public key Pᵢ truly corresponds to a device private key Sᵢ stored in a physical device 13 whose characteristics are specified in the field <info>, and it can therefore accept the request of the user 40 in issuing E35 the device certificate Cᵢ.

To do this, the trusted third party 44 issues a device certificate Cᵢ to the user 40 corresponding to the signature of the public key Pᵢ of the device, the identifier Idᵢ and pieces of information characteristic of the physical device.

According to one embodiment, when a user 40 wishes to register with a provider 43 so as to be able to make secured transactions with this provider, the different verification operations E33 to E34 described here above with reference to FIG. 3 can be done by the provider 43 itself or by a trusted third party 44 (AC) also connected to the network 42. In this case, the provider 43 transmits the two certificates namely the factory certificate C₀ and the provisional certificate C′ᵢ to the trusted third party 44 by means of the network 42. The certification server 45 of the ACP 10 which has created the factory certificate C₀ of the physical device 13 communicates or has communicated its public key P_{T} to the verification server or AC 44.

All that the trusted third party 44 has to do then is to use, firstly, the public certification key P_{T} of the certification server 45 to verify E33 the authenticity of the factory certificate C₀, and, secondly, the device public key P₀ of the device 13 to verify E34 the authenticity of the provisional certificate C′ᵢ.

The verification of the factory certificate C₀ can be done by a trusted third party 44 or by the ACP. This latter case is especially relevant in the case of a use of a symmetrical key K.

When the trusted third party 44 has issued the device certificate Cᵢ, this certificate is transmitted to the user's communications terminal 41 through the communications network 42 to which the registration server of the provider 43 is connected.

In general, a user 40 can register E35 with one or more different trusted third parties, each of which will issue a distinct device certificate Cᵢ linking the public key Pᵢ of the physical device 13 to an identifier Idᵢ of the user 40, relevant to the trusted third party considered.

When the registration E35 of the user 40 with the trusted third party has been done, the user can then start carrying out secured transactions with the provider 43: to do so, it uses its physical device 13 to sign a random value given by the provider (the term used in this case is authentication) or a message (the term used here is signature) using its device secret key Sᵢ, and by associating thereto the corresponding device certificate Cᵢ, according to the standard protocols which are not the object of the present patent application and shall therefore not be described herein in greater detail.

In other words, an embodiment of the invention does not modify the mode of use of a physical device to carry out an authentication, a signing, or even an enciphering operation. However, through an embodiment of the invention, the providers who need the device certificate Cᵢ (for example to verify an authentication or a signature or to encipher a message) have the possibility, if they so wish, of consulting the field <info>placed in an extension of the device certificate Cᵢ. The content of this field <info>assures the providers 43 who are in dialog with a user 40 that this user is truly in possession of a physical device 13 having characteristics contained in the field <info>.

As already indicated here above in this document, the quadruplet (P₀, S₀, C₀, <info>) may be the same for all the physical devices of a same given type, described in the field <info>(for example for all the USB dongles produced by a same manufacturer), so that all these devices carry the same device private key S₀. Conversely the quadruplet (P₀, S₀, C₀, <info>) may be specific to a given physical device. This second approach is more advantageous in terms of security and provides for greater efficiency in countering any attempts at fraud by users.

Indeed, if all the physical devices of a given type have the same quadruplet (P₀, S₀, C₀, <info>), and if, by mischance, a fraudulent individual succeeds in extracting the device private key S₀ from one of the devices (by physical attack, DPA or Differential Power Analysis, attack by concealed channels etc) the use of all these physical devices is jeopardized. Indeed, the fraudulent individual can then himself build a fraudulent device on the basis of the device private key S₀, or emulate it in software form. The trusted third party then has no means whatsoever of knowing if he is in the presence of a genuine physical device, acquired honestly, or a fraudulent device. This is a particularly problem-ridden issue.

If, however, the quadruplet (P₀, S₀, C₀, <info>) is specific to each device, it is still possible for a fraudulent individual to fraudulently get hold of the device private key S₀, but this fraudulent operation can be countered by setting up one or more of the following measures:

the trusted third party who issues the device certificates Cᵢ challenges the fraudulent quadruplet (P₀, S₀, C₀, <info>) and refrains from issuing device certificates Cᵢ to the users having this quadruplet during the registering phase;

the trusted third party communicates a list of the fraudulent quadruplet or quadruplets that it has detected to the ACP 10 which can then publish the list or make it available to all the trusted third parties or providers that place their trust in it so that none of them issues any more device certificates Cᵢ to the users having such quadruplets;

finally, each trusted third party challenges all the device certificates Cᵢ which have already been issued on the basis of a quadruplet identified as being fraudulent, in order to prevent such device certificates Cᵢ from being possibly used in order to make new transactions.

An embodiment of the invention therefore enables the performance of secured transactions between a user, who is a holder of a physical device, and one or more providers, while at the same time ensuring the untraceability of the user by the different providers. Indeed, if the device certificate Cᵢ is issued by a certification authority that is independent of the provider, the provider has access only to the device certificate Cᵢ, and hence to the extension field <info>associated with it. Provided that this field <info>contains only generic information on the physical device, the provider then cannot set up any link between the identifier Idᵢ associated with the device certificate Cᵢ and the physical device itself (identified in the above-described embodiment by a single quadruplet (P₀, S₀, C₀, <info>)).

If, however, it is sought to ensure a certain traceability of the physical device, for example solely by the ACP and the other certification authorities, it can be chosen to add an identification element of the physical device to the <info>field, for example its serial number. To maintain a guarantee of untraceability of the users by the providers, it is then necessary not to copy this serial number into the extension field <info>of the device certificate Cᵢ.

Conversely, if it is desired that the physical device should be traceable by at least some of the providers, it is enough to copy the serial number of the device into the <info>field of the device certificates Cᵢ of all the providers concerned.

An embodiment of the invention provides a technique for controlling secured transactions using a physical device that is associated with several pairs of asymmetric keys and can be used to conclude transactions with several distinct providers, making it possible to make sure that a transaction has been actually performed by means of a given physical device, while at the same time ensuring untraceability of the user by all or some of the providers.

An embodiment of the invention proposes a technique of this kind that is simple to implement and introduces little additional complexity into the physical devices used and very few modifications in the software programs and server of the providers or certification authorities.

An embodiment of the invention provides a technique of this kind that is reliable and can therefore be used to obtain a strong property of non-repudiation so as to create an environment of trust for the provider.

An embodiment of the invention provides a technique of this kind that can be used, if need be, to provide for the traceability of the customer by one or more certification authorities.

An embodiment of the invention proposes a technique of this kind that enables providers to access information on the characteristics (brand, type, algorithms used, etc) of the physical device with which they enter into dialog.

Although the present disclosure has been described with reference to one or more examples, workers skilled in the art will recognize that changes may be made in form and detail without departing from the scope of the disclosure and/or the appended claims.

1. Method for the control of secured transactions implementing a physical device held by a user and bearing at least one first pair of asymmetric keys, comprising a first device public key and a corresponding first device private key, wherein said control method comprises:
prior to commissioning said physical device, a first step of certifying said first device public key and pieces of information characteristic of the physical device by signing with a first certification key of a particular certification authority, issuing a factory certificate, after verification that said device private key S₀ is housed in a tamper-proof zone of said physical device;
a step of generation of at least one second pair of selected keys, comprising a second device public key and a second device private key, said second device private key being housed in a tamper-proof zone of said device;
a second step of certification of said second device public key through signing by said first device private key, issuing a provisional certificates;
a first step of verification of said factory certificate by a second certification key corresponding to said first certification key;
a second step of verification of said provisional certificate by said first device public key; and
in the event of positive verification of said factory certificate and said provisional certificate, a step of issuance by a trusted third party of a device certificate corresponding to a signing of at least said second device public key, an identifier of said user and said pieces of information characteristic of the device.

2. Control method according to claim 1, wherein the method is implemented for at least two second pairs of asymmetric keys of said device, each associated with an identifier of said user and wherein each of said device certificates issued during said steps of issuance links one of said second device public keys to said associated identifiers.

3. Control method according to claim 1, wherein said pieces of information characteristic of said physical device belong to the group comprising the following pieces of information:
type of physical device;
identification of the manufacturer of said physical device;
type of cryptographic algorithm used by said physical device;
serial number of said physical device.

4. Control method according to claim 1, wherein, at the time of a transaction, a provider consults said pieces of information characteristic of said device certificate.

5. Control method according to claim 1, wherein the method comprises a phase of personalization of said physical device, during which said first pair of asymmetric keys, said factory certificate, and said pieces of information of said factory certificate are associated solely with said physical device so as to reduce risks of fraudulent transactions.

6. Control method according to claim 1, wherein said factory certificate and provisional certificate are stored in at least one freely read-accessible memory zone of said physical device.

7. Control method according to claim 4, wherein at least one of said first and second verification steps is performed by said provider.

8. Control method according to claim 1, wherein said first certification key is a private key and said second certification key is a public key.

9. Control method according to claim 1, wherein said particular certification authority uses a symmetrical key, so that said first certification key and said second certification key are identical.

10. Physical device held by a user and designed to be used during secured transactions, said physical device bearing at least one first pair of asymmetric keys, comprising a first device public key and a corresponding first device private key, and at least one second pair of asymmetric keys comprising a second device public key and a corresponding second device private key, wherein the physical device is associated with a factory certificate, issued after it has been verified that said device private key is housed in a tamper-proof zone of said physical device corresponding to a signing of said first device public key and of pieces of information characteristic of the physical device by a first certification key of a particular certification authority and wherein the physical devices is associated with a provisional certificate corresponding to a signing of said second device public key by said first device private key, and wherein said factory certificate is stored in said physical device prior to its commissioning or provided to the user of said physical device on an external carrier, or again communicated to providers or trusted third parties who might need the factory certificate.

11. Computer program product network and/or stored on a carrier that is computer-readable and/or executable by a microprocessor, wherein the product comprises program code instructions to implement at least one step of a method for controlling secured transactions implementing a physical device held by a user and bearing at least one first pair of asymmetric keys, comprising a first device public key and a corresponding first device private key, wherein said method comprises:
prior to commissioning said physical device, a first step of certifying said first device public key and pieces of information characteristic of the physical device by signing with a first certification key of a particular certification authority, issuing a factory certificate, after verification that said device private key is housed in a tamper-proof zone of said physical device;
a step of generation of at least one second pair of selected keys, comprising a second device public key and a second device private key, said second device private key being housed in a tamper-proof zone of said device;
a second step of certification of said second device public key through signing by said first device private key, issuing a provisional certificate:
a first step of verification of said factory certificate by a second certification key corresponding to said first certification key;
a second step of verification of said provisional certificate by said first device public key; and
in the event of positive verification of said factory certificate and said provisional certificate, a step of issuance by a trusted third party of a device certificate corresponding to the signing of at least said second device public key, an identifier of said user and said pieces of information characteristic of the device.

12. System for controlling secured transactions in a communications network, implementing a physical device held by a user and bearing at least one pair of asymmetric keys, comprising a first device public key and a corresponding first device private key, wherein the system comprises at least:
a particular certification server connected to said network, issuing to said physical device, after verification that said device private key is housed in a tamper-proof zone of said physical device and prior to its commissioning, a factory certificate corresponding to a signing of said first device public key and pieces of information characteristic of the physical device by a first certification key of said particular certification server;
a trusted third party verifying said factory certificate by a second certification key corresponding to said first certification key, and a provisional certificate stored in said physical device, corresponding to a signing of a second device public key by said first device private key, by said first device public key, and issuing to said user, in the event of positive verification, a device certificate corresponding to a signing by said trusted third party, of at least said second device public key, an identifier of said user and pieces of information characteristic of the device, said trusted third party being linked to said network.
